(19) United States
(12) Patent Application Publication
(10) Pub. No.: US 2025/0256511 A1
(43) Pub. Date: Aug. 14, 2025

(54) LIQUID DROPLET EJECTION APPARATUS, HEAD CLEANING METHOD, AND STORAGE MEDIUM

(71) Applicant: Konica Minolta, Inc., Tokyo (JP)

(72) Inventors: Katsuhiro UMEDA, Tokyo (JP); Yohei ITO, Tokyo (JP)

(21) Appl. No.: 19/045,664

(22) Filed: Feb. 5, 2025

(30) Foreign Application Priority Data
Feb. 14, 2024 (JP) 2024-019920

(51) Int. Cl. B41J 2/165; B41J 11/00

(52) U.S. Cl. CPC B41J 2/16535; B41J 11/0015; B41J 11/0095; B41J 2002/16573; B41P 2235/21

(57) ABSTRACT

A liquid droplet ejection apparatus includes an image former that ejects a liquid droplet from a nozzle of a liquid droplet ejection head onto a recording medium conveyed, thereby recording an image thereon, a head cleaning device that cleans a nozzle face of the liquid droplet ejection head, and a hardware processor that controls a cleaning operation of the head cleaning device in accordance with information on an amount of charge on the recording medium.

### CROSS-REFERENCE TO RELATED APPLICATIONS

The entire disclosure of Japanese Patent Application No. 2024-019920 filed on Feb. 14, 2024, is incorporated herein by reference in its entirety.

### BACKGROUND OF THE INVENTION

### Technical Field

The present invention relates to a liquid droplet ejection apparatus, a head cleaning method, and a storage medium.

### Description of Related Art

A liquid droplet ejection apparatus has been known that performs an image forming operation by ejecting liquid droplets from nozzles of a liquid droplet ejection head onto a recording surface of a recording medium. The liquid droplet ejection apparatus ejects liquid droplets from the nozzles at appropriate timings on the basis of image data.

In such a liquid droplet ejection apparatus, when an image forming operation is performed with mist adhered to the nozzle face left as it is, image quality decreases due to ejection deflection or ejection failure of liquid droplets. Therefore, it is necessary to clean the nozzle face of the liquid droplet ejection apparatus.

Therefore, for example, Japanese Unexamined Patent Publication No. 2009-101630 describes an inkjet recording apparatus that controls cleaning of the nozzle face by estimating the state of the nozzle face on the basis of various conditions.

### SUMMARY OF THE INVENTION

However, the invention of Japanese Unexamined Patent Publication No. 2009-101630 does not take the amount of charge on a recording medium into controlling cleaning of the nozzle face. FIG. 4A is a graph showing a relationship between the amount of charge on a recording medium, the amount of mist that adheres to the nozzle face, and the amount of satellite that lands on the recording medium. FIG. 4B is a diagram showing the state of mist that adheres to the nozzle face and the state of satellite that adheres to a recording medium for each amount of charge on a recording medium. In FIG. 4A, the horizontal axis represents the amount of charge on a recording medium, and the vertical axis represents the number of particles of mist that adhere to the nozzle face or the number of particles of satellite that land on a recording medium. As illustrated in FIGS. 4A and 4B, as the amount of charge on the recording medium increases, the amount of mist that adheres to the nozzle face dramatically increases. In the invention of Japanese Unexamined Patent Publication No. 2009-101630, the nozzle face is not cleaned in accordance with the amount of charge, and thus the quality of an image to be formed may deteriorate.

In addition, if the frequency of cleaning of the nozzle face or the intensity of cleaning thereof is idly increased, the productivity of image recording decreases due to increase in downtime, and the liquid droplet ejection head deteriorates due to wearing of the nozzle face.

The present invention has been made in view of such circumstances. An object of the present invention is to provide a liquid droplet ejection apparatus, a head cleaning method and a non-transitory computer-readable storage medium storing a program that can reduce a decrease in quality of an image to be formed by more appropriately removing mist adhered to a nozzle face.

To achieve at least one of the abovementioned objects, according to an aspect of the present invention, a liquid droplet ejection apparatus reflecting one aspect of the present invention includes:
an image former that ejects a liquid droplet from a nozzle of a liquid droplet ejection head onto a recording medium conveyed, thereby recording an image thereon;
a head cleaning device that cleans a nozzle face of the liquid droplet ejection head; and
a hardware processor that controls a cleaning operation of the head cleaning device in accordance with information on an amount of charge on the recording medium.

According to an aspect of the present invention, a head cleaning method reflecting one aspect of the present invention is performed by a liquid droplet ejection apparatus including an image former that ejects a liquid droplet from a nozzle of a liquid droplet ejection head onto a recording medium conveyed, thereby recording an image thereon and a head cleaning device that cleans a nozzle face of the liquid droplet ejection head; and includes:
controlling a cleaning operation of the head cleaning device in accordance with information on an amount of charge on the recording medium.

According to an aspect of the present invention, a non-transitory computer readable storage medium reflecting one aspect of the present invention stores a program causing, of a liquid droplet ejection apparatus including an image former that ejects a liquid droplet from a nozzle of a liquid droplet ejection head onto a recording medium conveyed, thereby recording an image thereon and a head cleaning device that cleans a nozzle face of the liquid droplet ejection head, a computer to:
control a cleaning operation of the head cleaning device in accordance with information on an amount of charge on the recording medium.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a sectional side view of a liquid droplet ejection apparatus;

FIG. 2 is a block diagram of the liquid droplet ejection apparatus;

FIG. 3 is a flowchart of a nozzle face cleaning process;

FIG. 4A is a graph summarizing a relationship between satellite that lands on a recording medium and mist that adheres to a nozzle face of the liquid droplet ejection apparatus according to the amount of charge on the recording medium; and

FIG. 4B is a schematic view of the nozzle face of the liquid droplet ejection apparatus and the recording medium in accordance with the amount of charge on the recording medium.

### DETAILED DESCRIPTION

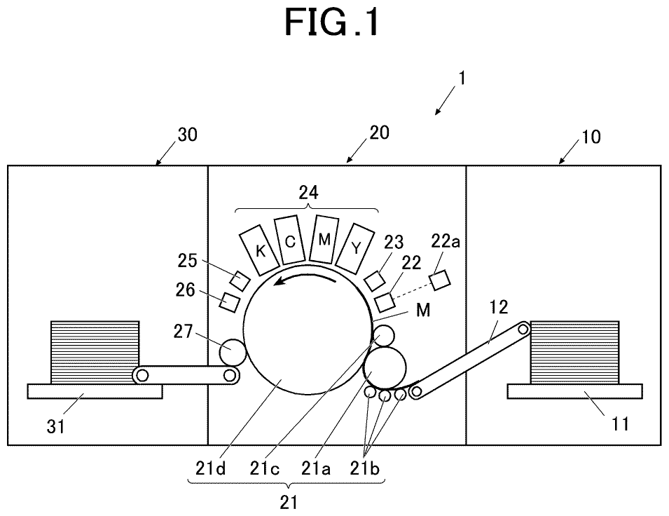

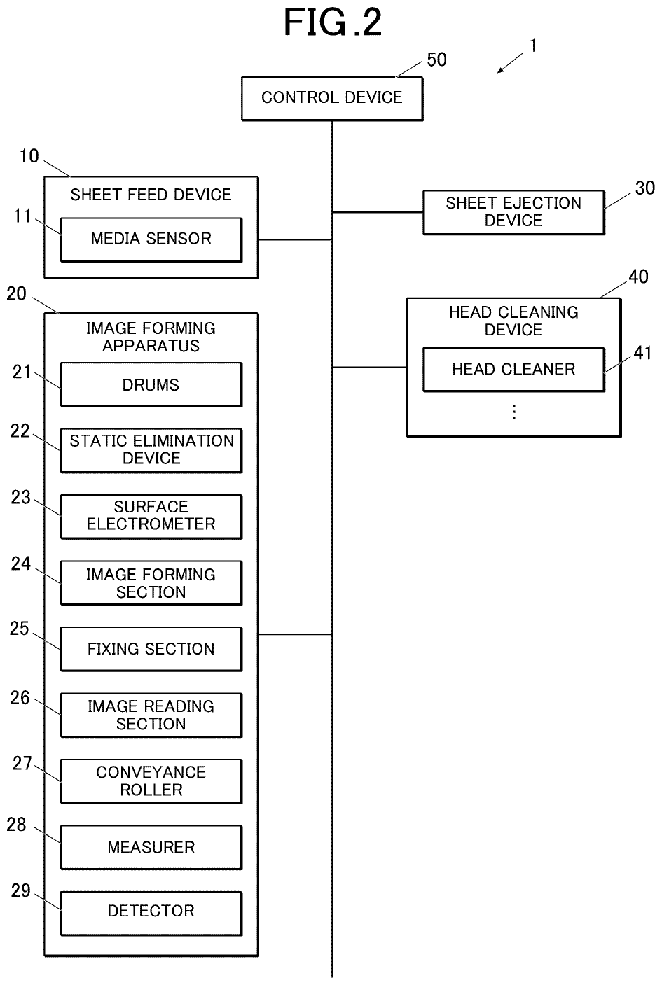

Hereinafter, a liquid droplet ejection apparatus according to one or more embodiments of the present invention will be described in detail with reference to the drawings. However, the scope of the invention is not limited to the embodiments or illustrated examples. Hereinafter, components having the same function and configuration are denoted by the same reference sign, and the same description will be omitted.

[Overall Configuration of Liquid Droplet Ejection Apparatus] FIG. 1 is a sectional side view illustrating a schematic configuration of an inkjet recording apparatus 1 that is an embodiment of a liquid droplet ejection apparatus of the present invention. FIG. 2 is a block diagram illustrating a functional configuration of the inkjet recording apparatus 1. The inkjet recording apparatus 1 includes a sheet feed device 10, an image forming apparatus 20, a sheet ejection device 30, a head cleaning device 40, and a control device 50 (hardware processor). The inkjet recording apparatus 1 forms an image by ejecting ink droplets from the image forming apparatus 20 onto a recording medium M conveyed from the sheet feed device 10, and ejects the recording medium M to the sheet ejection device 30.

### Sheet Feed Device

The sheet feed device 10 includes a sheet feed tray 11 and a sheet feed section 12. The sheet feed tray 11 stores recording media M. The sheet feed section 12 conveys a recording medium(s) M to the image forming apparatus 20 under the control of the control device 50.

Note that the recording media M are not limited to paper such as plain paper or coated paper. As the recording medium M, various types of media can be used as far as ink droplets landed on the surface thereof can be fixed, such as cloth or sheet-like resin. In FIG. 1, the sheet feed device 10 includes one sheet feed tray 11, but the present invention is not limited thereto. The sheet feed device 10 may include two or more sheet feed trays 11 that store multiple types of recording media M.

### Image Forming Apparatus

### {Drum}

The image forming apparatus 20 includes multiple types of drums 21 for conveying the recording medium M. In the present embodiment, the multiple types of drums 21 include an A drum 21a, A drum press rollers 21b, a recording medium press roller 21c, and a triple-sized drum 21d. The drums 21 convey the recording medium M in a conveyance direction by nipping/holding the recording medium M.

The image forming apparatus 20 further includes a static elimination device 22, a surface electrometer 23, an image forming section 24 (image former), a fixing section 25, an image reading section 26 (image reader), and a conveyance roller 27.

### {Static Elimination Device}

The static elimination device 22 is provided on the upstream of the image forming section 24 in the conveyance direction. The static elimination device 22 is a static eliminator that eliminates a voltage applied to the recording medium M. For example, the static elimination device 22 eliminates charge by holding the recording medium M with a conductive roller connected to the ground (GND).

The static elimination device 22 further includes a static elimination performance measurement device 22a that measures static elimination performance of the static elimination device 22 by obtaining, for example, current values of the recording medium M on the upstream side and the downstream side of the static elimination device 22 in the conveyance direction.

### {Surface Electrometer}

The surface electrometer 23 is provided on the upstream side of the image forming section 24 in the conveyance direction and in the vicinity of the image forming section 24. The surface electrometer 23 detects surface potential on the recording medium M. The surface potential on the recording medium M detected by the surface electrometer 23 is transmitted to the control device 50.

### {Image Forming Section}

The image forming section 24 forms an image on the recording medium M conveyed by the drum(s) 21 (triple-sized drum 21d). In the present embodiment, as illustrated in FIG. 1, the image forming section 24 includes a plurality of head units each including a plurality of inkjet heads. Each head unit forms an image by ejecting ink of a color from nozzle openings facing the conveyance face of the triple-sized drum 21d at appropriate timing corresponding to rotation of the triple-sized drum 21d holding the recording medium M. The colors of ink ejected by the head units are, for example, four colors of Y (yellow), M (magenta), C (cyan) and K (black), but not limited thereto.

The head units are arranged such that their nozzle openings are separated from the conveyance face of the triple-sized drum 21d by a predetermined distance. Further, under the control of the control device 50, the head units each move to a position where their nozzle faces face the head cleaning device 40 in a nozzle face cleaning process, which will be described later, or the like.

### {Fixing Section}

The fixing section 25 is provided on the downstream side of the image forming section 24 in the conveyance direction. The fixing section 25 fixes the image formed on the recording medium M by the image forming section 24. The fixing section 25 is, for example, an energy ray irradiator. To be specific, the fixing section 25 includes a light emitter arranged over the width of the conveyance face of the triple-sized drum 21d in the orthogonal direction. The light emitter emits energy rays, such as ultraviolet rays, onto the conveyed recording medium M under the control of the control device 50. This cures the ink on the recording medium M, thereby fixing the ink thereto.

### {Image Reading Section}

The image reading section 26 is provided on the downstream side of the fixing section 25 in the conveyance direction so as to be able to read the image forming face that is the surface of the recording medium M. The image reading section 26 is, for example, a line sensor or the like. The image reading section 26 reads the image forming face of the recording medium M in a predetermined reading area, and transmits image data to the control device 50.

### {Conveyance Roller}

The conveyance roller 27 is provided on the downstream side of the image reading section 26 in the conveyance direction. The conveyance roller 27 conveys the recording medium M delivered from the triple-sized drum 21d, the recording medium M having passed through the image forming section 24 and the fixing section 25, to the sheet ejection device 30.

### Sheet Ejection Device

The sheet ejection device 30 stores recording medium M ejected from the image forming apparatus 20 until a user collects it. The sheet ejection device 30 includes a sheet ejection tray 31 having a plate shape. Note that the sheet ejection device 30 may include a plurality of sheet ejection trays 31, similarly to the sheet feed device 10. In the configuration, the sheet ejection device 30 appropriately controls the storage destination of the recording medium M in accordance with an instruction from the control device 50 corresponding to an image forming condition(s) of the image forming apparatus 20.

### Head Cleaning Device

The head cleaning device 40 removes ink mist adhered to the nozzle face of the inkjet heads. The head cleaning device 40 includes, for example, multiple types of head cleaners 41.

For example, the head cleaners 41 included in the head cleaning device 40 include a cleaning blade. The cleaning blade is a metal member that is made of, for example, stainless steel or the like to have a property of not being eroded by ink, and has a shape of a rectangular plate bent so as to protrude toward the nozzle face. When the head units move, the cleaning blade contacts only the ink mist on their nozzle faces in a non-contact state with respect to the nozzle faces, thereby scraping off relatively large particles of ink mist.

As another example, the head cleaners 41 included in the head cleaning device 40 include a cleaning wipe. The cleaning wipe is, for example, an absorbent sheet bridged over a roller pair including a plurality of rollers. Every time the sheet or the like comes into contact with the nozzle face to wipe the ink, the wiping face is wound by the roller pair, and the other face forms the wiping face.

As another example, the head cleaners 41 included in the head cleaning device 40 include a cleaning roller. The cleaning roller is, for example, a web roller or a sponge roller in which a web layer or an elastic layer is formed on a cored bar made of metal. The cleaning roller wipes the ink by rotating in contact with the nozzle face under the control of the control device 50.

The head cleaning device 40 may include, for example, a liquid ejector that softens the ink by ejecting liquid such as water or cleaning liquid. Alternatively, the above-described cleaning blade, cleaning wipe and cleaning roller may be appropriately immersed in the above-described liquid as necessary.

The head cleaners 41 included in the head cleaning device 40 are not limited to any one or more of the above examples, and appropriate known components can be adopted.

### Control Device

The control device 50 controls operation of each device/apparatus constituting the inkjet recording apparatus 1. The control device 50 includes a central processing unit (CPU), a random access memory (RAM), and a read only memory (ROM).

The CPU executes various kinds of arithmetic processing. The CPU comprehensively controls the overall operation of the inkjet recording apparatus 1. The RAM provides a working memory space for the CPU and stores temporary data. The ROM stores various control programs to be executed by the CPU, setting data, and the like. Note that instead of the ROM, a rewritable nonvolatile memory such as an electrically erasable programmable read only memory (EEPROM) or a flash memory may be used.

### Nozzle Face Cleaning Process

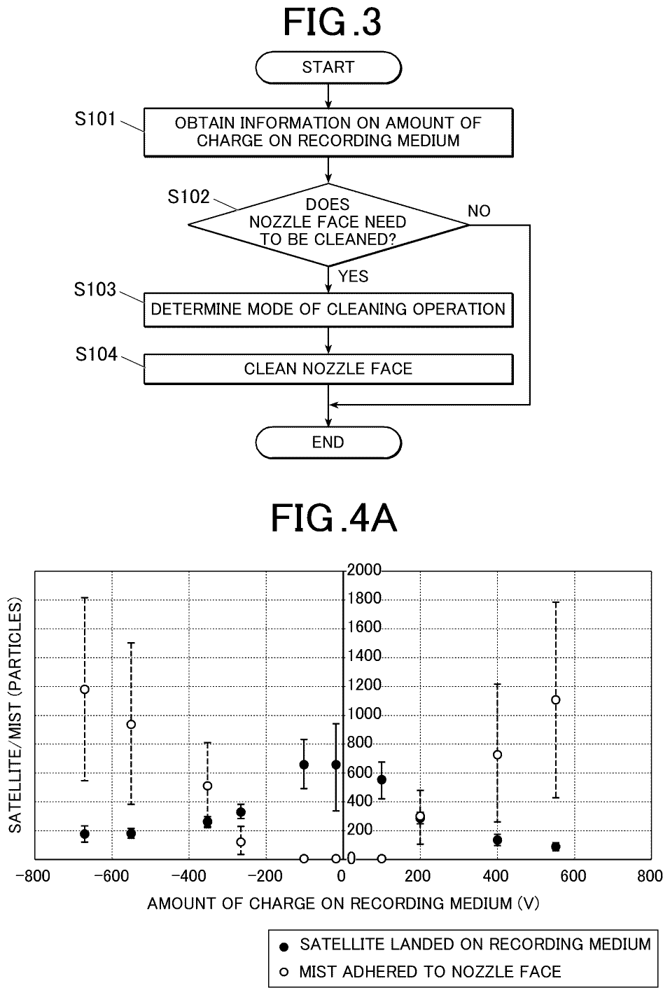

The nozzle face cleaning process by the head cleaning device 40 in the inkjet recording apparatus 1 described above will be described with reference to the flowchart of FIG. 3. In the nozzle face cleaning process, the control device 50 controls the operation of the head cleaning device 40 in accordance with information on the amount of charge on a recording medium M. More specifically, the control device 50 determines whether the nozzle face is to be cleaned by the head cleaning device 40 in accordance with the information on the amount of charge on a recording medium M, and if so, determines the mode thereof.

The control device 50 obtains information on the amount of charge on a recording medium M (Step S101). The information on the amount of charge includes a measured value or an estimated value of the amount of charge on the recording medium M and information for correcting the estimated value. In the present embodiment, the control device 50 obtains, from the surface electrometer 23, a measured value of the amount of charge on the recording medium M before the image forming section 24 ejects ink droplets onto the recording medium M. Then, the control device 50 calculates a cumulative value of measured values of the amount of charge on recording media M, and controls the cleaning operation of the head cleaning device 40 on the basis of the cumulative value. Thus, the control device 50 functions as an obtaining section that obtains the amount of charge from the surface potential measured by the surface electrometer 23.

To begin with, recording media M are charged by their contact with, rubbing against and separation from one another, and their contact with, rubbing against and separation from the conveyance members including the drums 21. Therefore, in the present embodiment, the aforementioned “before the image forming section 24 ejects ink droplets onto the recording medium M” is any time between placement of the recording medium M on the triple-sized drum 21d and image formation by the image forming section 24. With this configuration, it is possible, for example, to clean the nozzle face more appropriately as compared with a case where the amount of charge on a recording medium M in the sheet feed device 10 is referred to. In particular, it is further preferable that “before the image forming section 24 ejects ink droplets onto the recording medium M” is immediately before the image forming section 24 ejects ink droplets onto the recording medium M.

The control device 50 determines whether the nozzle face needs to be cleaned by the head cleaning device 40 on the basis of the information on the amount of charge on the recording medium M obtained in Step S101 (Step S102). If the control device 50 determines that the nozzle face does not need to be cleaned (Step S102; No), the control device 50 ends the nozzle face cleaning process.

If the control device 50 determines that the nozzle face needs to be cleaned (Step S102; Yes), the control device 50 determines, on the basis of the information on the amount of charge on the recording medium M, a mode of the cleaning operation of the head cleaning device 40 on the nozzle face (Step S103).

The mode of the cleaning operation determined by the control device 50 includes the timing, the strength, the number of times and/or the like of the cleaning operation. In the case where the head cleaning device 40 includes multiple types of head cleaners 41, the mode includes information on which of the head cleaners 41 is used to clean the nozzle face. Specifically, for example, when the amount of charge on the recording medium M is large, it is assumed that a large amount of ink mist adheres to the nozzle face. Therefore, the control device 50 determines a mode of the cleaning operation of the head cleaning device 40 in which a relatively large ink mist can be scraped off with the blade.

The control device 50 controls and causes the head cleaning device 40 in accordance with the determined mode to clean the nozzle face (Step S104). After the nozzle face is cleaned, the control device 50 ends the nozzle face cleaning process.

### Effects of Embodiment

As described above, the inkjet recording apparatus 1 according to the present embodiment includes the image forming section 24 that records an image by ejecting liquid droplets from the nozzles of the liquid droplet ejection heads onto a recording medium M conveyed thereto. The inkjet recording apparatus 1 further includes the head cleaning device 40 that cleans the liquid droplet ejection heads, and the control device 50. The control device 50 controls the cleaning operation of the head cleaning device 40 in accordance with the information on the amount of charge on the recording medium M.

According to this configuration, it is possible to reduce the decrease in the quality of an image to be formed by appropriately removing mist adhered to the nozzle face according to the amount of charge on the recording medium M. Further, according to the configuration, it is possible to predict stain/damage on the nozzle face of the inkjet heads according to the information on the amount of charge on the recording medium M, the information obtainable in advance. Therefore, as compared with, for example, a configuration in which the state of the nozzle face is detected for cleaning, the decrease in the quality of an image to be formed on a recording medium M can be prevented, and the decrease in productivity can be reduced.

### Other Configurations

Although one or more embodiments according to the present invention have been detailed above, the present invention is not limited to the above-described embodiments. Various modifications can be made within the scope of the invention described in claims and the scope of their equivalents.

For example, in the above, the control device 50 is configured to obtain the amount of charge itself on the recording medium M, but not limited thereto. For example, the control device 50 may obtain the type of the recording medium M as the information on the amount of charge. Specifically, a conversion table of the type of the recording medium M and the amount of charge thereon is obtained in advance by experiment and stored in the ROM. Then, the control device 50 calculates the cumulative amount of charge from the type of the recording medium M and the conversion table, and controls the operation of the head cleaning device 40.

Note that the recording medium M is especially likely to be charged if it is of polyvinyl chloride (PVC) or plastic media. Therefore, in the above-described configuration, if the recording medium M is of plastic-based media as described above, the conversion table is set such that the amount of charge is greater than that of other media.

Further, the control device 50 may obtain a physical property of the recording medium M as the information on the amount of charge. Examples of the physical property of the recording medium M include resistance and permittivity. Specifically, a conversion table of the physical property of the recording medium M and the amount of charge thereon is obtained in advance by experiment and stored in the ROM. Further, a media sensor 11 that measures the physical property of the recording medium M is provided in the sheet feed device 10 or the like, and the measurement result is transmitted to the control device 50. Then, the control device 50 calculates the cumulative amount of charge from the physical property of the recording medium M and the conversion table, and controls the operation of the head cleaning device 40.

Further, if the static elimination performance of the static elimination device 22 is low, the amount of charge on the recording medium M remains relatively great. Therefore, the control device 50 may obtain the measurement result of the static elimination performance measurement device 22a as the information on the amount of charge.

In the above, the image forming apparatus 20 includes the static elimination device 22, but it is not preferable to enhance the static elimination effect on the recording medium M, for example, by providing many static elimination devices 22. For example, in a case where the static elimination device 22 is an ionizer that blows ion wind toward the recording medium M, if the static elimination effect is too high, the ink may be thickened by ozone or a discharge product, and malfunction may occur in the inkjet heads.

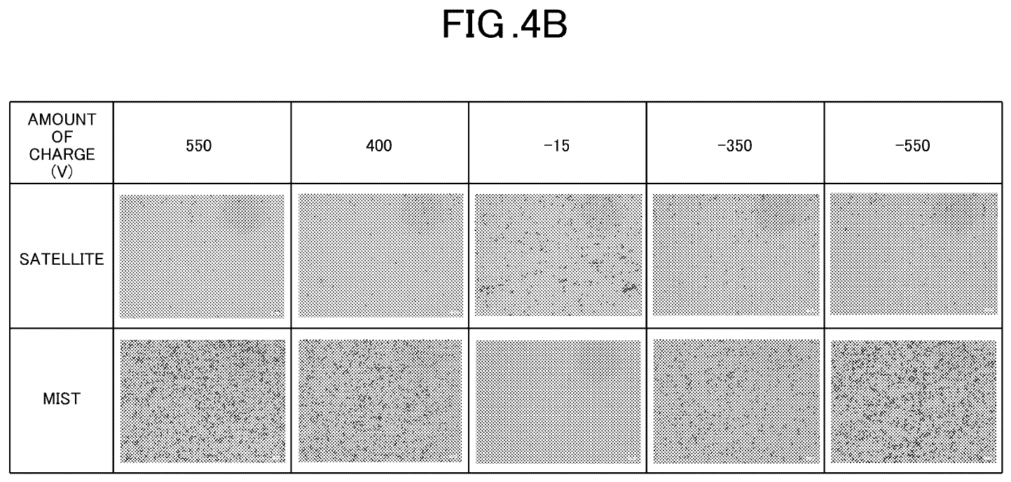

Further, as illustrated in FIG. 4A and FIG. 4B, the amount (situation) of satellite adhering to the recording medium M also changes according to the amount of charge on the recording medium M. Further, the shape of dots also changes according to the amount of charge on the recording medium M. Specifically, if the amount of charge on the recording medium M is large, the shape of dots is distorted. These changes can be detected by the control device 50 from the reading result of the image reading section 26. Therefore, the control device 50 may obtain the reading result of the image reading section 26 as the information on the amount of charge.

Further, for example, if it is winter and the temperature is low, the recording medium M is likely to be charged. Therefore, the control device 50 may obtain temperature information and/or humidity information measured by a measurer 28 as the information on the amount of charge. The temperature information and the humidity information are not limited to the state of the external environment, and may include the temperature and the humidity of the recording medium M.

Further, a detector 29 that detects mist adhered to the nozzle face may be provided in the vicinity of each head unit, and the control device 50 may use the detection result together with the information on the amount of charge on the recording medium M to control the cleaning operation of the head cleaning device 40. Specifically, the detector 29 is a camera or a sensor. In the above-described configuration, the control device 50 calculates the adhesion amount of mist from the density on the nozzle face obtained from the detector 29.

The control device 50 may use any one or more of the operating time, the number of image-formed sheets, the image forming condition and the ink consumption of the inkjet recording apparatus 1 together with the information on the amount of charge on the recording medium M to control the cleaning operation of the head cleaning device 40. Note that examples of the image forming condition include the number of inkjet heads to be used, an image pattern, and the like.

Further, in the above, the liquid droplet ejection apparatus is the inkjet recording apparatus 1 that ejects ink, but not limited thereto. That is, the liquid ejected by the liquid droplet ejection apparatus is not limited to ink, and may be any appropriate liquid such as a pretreatment agent.

Further, in the above, the inkjet recording apparatus 1 is configured to include the head cleaning device 40, but not limited thereto. The head cleaning device 40 may be a device separate from the inkjet recording apparatus 1 as long as it has the same function(s) and effect(s) as those described above. Similarly, in the above, the inkjet recording apparatus 1 includes the control device 50, but not limited thereto. The control device 50 may be a device separate from the inkjet recording apparatus 1 as long as it has the same function(s) and effect(s) as those described above.

Further, in the above, the head units are moved to the position where their nozzle faces face the head cleaning device 40 in the nozzle face cleaning process, but this is no limitation. That is, a configuration may be adopted in which the cleaner(s) 41 of the head cleaning device 40 is moved to a position where the cleaner 41 faces the nozzle face(s).

Further, in the above, as a computer-readable medium storing the program(s) according to the present invention, a hard disk, a semiconductor nonvolatile memory or the like is used as an example, but the present invention is not limited thereto. As the computer-readable medium, a portable storage medium, such as a CD-ROM, can also be used. Further, a carrier wave may be used as a medium that provides data of the program(s) according to the present invention via a communication line.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2024-019920, filed on Feb. 14, 2024, including description, claims, drawings and abstract is incorporated herein by reference.

What is claimed is:

1. A liquid droplet ejection apparatus comprising:
an image former that ejects a liquid droplet from a nozzle of a liquid droplet ejection head onto a recording medium conveyed, thereby recording an image thereon;
a head cleaning device that cleans a nozzle face of the liquid droplet ejection head; and
a hardware processor that controls a cleaning operation of the head cleaning device in accordance with information on an amount of charge on the recording medium.

2. The liquid droplet ejection apparatus according to claim 1, wherein the hardware processor controls the cleaning operation of the head cleaning device in accordance with the amount of charge on the recording medium before the image former ejects the liquid droplet onto the recording medium.

3. The liquid droplet ejection apparatus according to claim 2, comprising a surface electrometer on an upstream side of the image former in a conveyance direction, the surface electrometer measuring a surface potential on the recording medium,
wherein the hardware processor obtains the amount of charge from the surface potential measured by the surface electrometer.

4. The liquid droplet ejection apparatus according to claim 1, wherein the hardware processor controls the cleaning operation of the head cleaning device in accordance with the information on the amount of charge set for each type of the recording medium.

5. The liquid droplet ejection apparatus according to claim 1, comprising a media sensor that measures a physical property of the recording medium,
wherein the hardware processor controls the cleaning operation of the head cleaning device in accordance with the information on the amount of charge corresponding to a measurement result of the measurement by the media sensor.

6. The liquid droplet ejection apparatus according to claim 1, comprising:
a static elimination device that performs static elimination on the recording medium; and
a static elimination performance measurement device that measures static elimination performance of the static elimination device,
wherein the hardware processor controls the cleaning operation of the head cleaning device in accordance with the information on the amount of charge corresponding to a measurement result of the measurement by the static elimination performance measurement device.

7. The liquid droplet ejection apparatus according to claim 1, comprising an image reader that reads the image formed on the recording medium by the image former,
wherein the hardware processor controls the cleaning operation of the head cleaning device in accordance with the information on the amount of charge corresponding to a reading result of the reading by the image reader.

8. The liquid droplet ejection apparatus according to claim 1, comprising a measurer that measures temperature information and/or humidity information,
wherein the hardware processor controls the cleaning operation of the head cleaning device in accordance with the information on the amount of charge corresponding to a measurement result of the measurement by the measurer.

9. The liquid droplet ejection apparatus according to claim 1, comprising a detector that detects an amount of mist adhered to the nozzle face,
wherein the hardware processor controls the cleaning operation of the head cleaning device in accordance with the information on the amount of charge and a detection result of the detection by the detector.

10. The liquid droplet ejection apparatus according to claim 9, wherein the detector is a camera or a sensor.

11. The liquid droplet ejection apparatus according to claim 1, wherein the hardware processor controls the cleaning operation of the head cleaning device in accordance with the information on the amount of charge and one or more of an operating time, a number of image-formed sheets, an image forming condition and a liquid consumption of the liquid droplet ejection apparatus.

12. The liquid droplet ejection apparatus according to claim 1, wherein the hardware processor controls, as the cleaning operation, a timing at which the head cleaning device cleans the nozzle face.

13. The liquid droplet ejection apparatus according to claim 1, wherein the hardware processor controls, as the cleaning operation, a strength with which the head cleaning device cleans the nozzle face.

14. The liquid droplet ejection apparatus according to claim 1, wherein the hardware processor controls, as the cleaning operation, a number of times the head cleaning device cleans the nozzle face.

15. The liquid droplet ejection apparatus according to claim 1,
wherein the head cleaning device includes multiple types of head cleaners, and
wherein the hardware processor controls, as the cleaning operation, which of the multiple types of head cleansers is used.

16. A head cleaning method that is performed by a liquid droplet ejection apparatus including an image former that ejects a liquid droplet from a nozzle of a liquid droplet ejection head onto a recording medium conveyed, thereby recording an image thereon and a head cleaning device that cleans a nozzle face of the liquid droplet ejection head; the head cleaning method comprising:
controlling a cleaning operation of the head cleaning device in accordance with information on an amount of charge on the recording medium.

17. A non-transitory computer-readable storage medium storing a program causing, of a liquid droplet ejection apparatus including an image former that ejects a liquid droplet from a nozzle of a liquid droplet ejection head onto a recording medium conveyed, thereby recording an image thereon and a head cleaning device that cleans a nozzle face of the liquid droplet ejection head, a computer to:
control a cleaning operation of the head cleaning device in accordance with information on an amount of charge on the recording medium.
